(19) United States
(12) Patent Application Publication
(10) Pub. No.: US 2006/0272831 A1
(43) Pub. Date: Dec. 7, 2006

(54) Improved method and apparatus for hazardous vapor suppression fire prevention and/or fire extinguishment

(76) Inventor: Dwight P. Williams, Vidor, TX (US)

Correspondence Address: Sue Z. Shaper, 1800 West Loop South, Suite 750, Houston, TX, 77027, US

(21) Appl. No.: 10/572,292

(22) PCT Filed: Dec. 19, 2003
(86) PCT No.: PCT/US03/40882

§ 371 Date: Mar. 14, 2006

Related U.S. Application Data
(60) Provisional application No. 60/506,870, filed on Sep. 29, 2003.

(51) Int. Cl. A62C 3/00; A62C 2/00

(52) U.S. Cl. 169/45; 169/43; 169/46

(57) ABSTRACT

Apparatus and methods for protecting potentially hazardous areas from flammable vapors, gases and/or fire, including use of one or more portable adjustable base, monitor and nozzle apparatus systems.

### CROSS REFERENCE TO RELATED APPLICATIONS

This application is a continuation-in-part of, and claims priority to, U.S. Ser. No. 60/506,870, entitled Method for Protecting Against Hazardous Vapors, filed Sep. 29, 2003.

[For U.S. Application only: This application is also a continuation-in-part of application Ser. No. 09/569,178, filed May 11, 2000, entitled (Daspit Tool) Portable Wall-Attachable Fire Fighting Apparatus and Method, which is a continuation-in-part of PCT Application Serial No. US98/21720, filed Oct. 14, 1998, entitled Portable Wall-Attachable Fire Fighting Apparatus and Method.]

### FIELD OF THE INVENTION

The instant invention pertains to apparatus and methods for hazardous vapor suppression and fire fighting, and more particularly to portable adjustable monitor apparatus systems and methods of use. The invention is applicable in particular for fighting liquid storage tank seal fires, for inhibiting hazardous vapor release from tanks having sunken or dislodged roofs and for blanketing tank roof seal fires with foam The invention is applicable in general for affording reliable, adjustable and flexible protection for newly identified hazards, including protecting from the potential hazards of flammable vapors and/or gases which could arise from earthquakes or terrorist events. The invention includes improved monitor anchoring means and improved automatic sensing systems relating thereto.

### BACKGROUND OF THE INVENTION

Industrial fires, and industrial liquid storage tank fires in particular are typically fought utilizing portable nozzles, adjustably staged a distance from the fire. Use of such nozzles is referred to as a Type III application. The nozzles are usually held by hand or fixed to a monitor maneuvered into place by a fire truck, trailer or aerial.

Nozzles stationed a distance away from a tank target lose some percent of their fire fighting fluid to “fallout”, as the fluid transits the distance from the nozzle over the wall to the tank surface. Fallout is particularly noticeable and regrettable when throwing foam, an expensive product. A more precise, efficient and cost effective method of fighting certain industrial fires and hazardous vapor situations can be achieved by minimizing fallout. Fallout can be minimized by stationing a monitor and nozzle closer to the hazard, as for instance on the rim of a target tank wall itself or on a nearby wall or pipe structure. The instant invention discloses methods and apparatus for adjustably stationing monitors closer to a target area, in order to blanket an area with a fluid such as a foam to suppress vapors and/or to extinguish flammable liquid fire while minimizing fallout. The instant invention can also minimize the cost of the loss of equipment and the risk to personnel.

Preferred embodiments utilize a portable adjustable monitor apparatus, including a base and a monitor structured in combination (or a monitor structured to comprise a base,) to securely encompass a wall rim portion or a pipe portion, the apparatus having fittings for attaching to hose or lines. A wall could be a tank wall or any vertical wall, not necessarily a circular wall or a storage tank. The “wall” could be a pickup truck tailgate, a dozer blade or a cinderblock or concrete wall surrounding a flammable liquid storage area, depending upon the circumstances. A pipe for mounting could be any available pipe structure of adequate diameter, such as of at least a six-inch diameter. The apparatus base would preferably be designed for stability, low weight and versatility, ideally being adjustable to fit as many different wall or pipe-type structures as possible and to accommodate a variety of monitors. The apparatus, although portable, could of course be left in place for an indefinite time.

The monitor can have attached a variety of nozzles, but preferably would utilize either an automatic (pressure regulating) nozzle, which discharges the fire fighting fluid with a given authority and range by adjusting to discharge at a selected pressure, or a fixed flow nozzle, designed to discharge at a given a volumetric flow rate, presuming a nominal supply pressure. The nozzle could be a combination of the two. The nozzle might be self-educting or self-educing and self-metering.

Although the description herein recites that the apparatus win be supplied by fire fighting fluid via hoses, such “hose” could in fact be a pipe, including a fixed pipe. The word hose as used herein is intended to encompass pipes.

The fire fighting fluid is anticipated to be water or a water-foam concentrate solution which forms a foam upon application, as is known The fluid could, of course, be any effective or desired fire fighting fluid. Foam concentrate might be supplied to the nozzle via a separate pump or by self-duction or by both.

A further advantage, in addition to minimizing loss due to fallout, of a portable adjustable wall- or pipe-attachable monitor apparatus (and of methods of use) is that of minimizing risk to firefighters. The invention especially minimizes risk to personnel fighting tank seal fires and in sunken tank roof situations with fire potential. The apparatus and methods of use can be exploited to protect the installation and personnel on a flexible basis, minimizing the risk to workers and cost of loss of equipment in new and unforeseen hazardous areas. The instant apparatus is designed to apply a fire fighting fluid while allowing firefighters to remain largely remote. In contrast, for instance, in current practice firefighters are frequently called upon to walk the tank wind gutters or the tank pan itself in situations of tank roof seal fires or tank roof seal hazards or where sunken tank roofs are involved.

In the case of clearly foreseeable and anticipated hazardous areas, which could encompass an established reservoir or include process pumps and other equipment, which hazard area might be the occasion for a leak of flammable vapors and/or gases, it is known to place sensors in proximity to the potential sources of the hazard. The sensors are connected to a sprinkler system or to a fixed nozzle system, connecting through a valve to a source of fire fighting fluid. The sprinkler system typically dispenses water and/or water and a fire fighting foam. The water and/or water/foam can form a blanket for cooling and suppressing any hazardous vapor yield, prior to a fire, thereby eliminating two arms of the historic fire triangle (air, fuel, heat).

In the course of time and events, however, unanticipated and unforeseeable locales for potential hazards can arise. For these locales which there is no established sprinkler or fixed nozzle system. For some of these areas a traditional fixed sprinkler or fixed nozzle system might not even be possible, or at least easily adapted. Examples of such situations arise, for instance, during the repair of vessels or pumps or other equipment or in the case of temporary storage. Such situations could arise because of previously unanticipated causes, such as unpredicted levels of terrorism. In these unanticipated situations, a traditional sensor and sprinkler or fixed nozzle system might be impractical, or too expensive, or take too much time to install Furthermore, a traditional sprinkler and fixed nozzle system might suffer from the inherent disadvantage of being typically installed above a hazard. So situated, they run the risk of being damaged themselves by an explosion or fire before being effectively activated. The instant invention can address all of these problems.

Apparatus and method for hazardous vapor suppression and/or fire protection and extinguishment have been developed that includes deployment of a portable adjustable base/monitor/nozzle apparatus system, possibly associated with a sensor and a valve. The invention includes method and apparatus for the deployment of a plurality of such systems around a plurality of tanks associated with a preferably remote pump.

While industrial tanks containing liquids known to omit hazardous vapors are typically covered with a floating root events, such as an earthquake, can cause defects in the roofs, defects such as sinking or tilting. Such disasters can cause defects in a plurality of roofs at one site at one time, creating a large-scale potential hazard. The instant invention offers a cost effective means for planning for such disasters.

To protect against potential hazards, sensors can be set to detect the presence of hazardous levels of vapors around tanks in plants, refineries and tank farms and/or sensors can be set in the surrounding countryside and community, taking into account that vapors migrate. Upon the detection of a hazardous level of vapor by a sensor, regulations likely require the owner to cover the surface of the potentially hazardous area with a blanket of foam to suppress the vapor and also to maintain that blanket until the situation can be otherwise ameliorated.

Foam concentrates are expensive. A cost effective means for preparing to establish and for establishing and for maintaining a foam blanket in a hazard area (such as a tank with a tilted or sunken roof or the lice) is of value. Cost effective means are particularly valuable when an owner must plan for a hazardous situation arising among a plurality of tanks simultaneously.

A significant defect of commonly available portable foam applying equipment, such as monitors and nozzles located on fire trucks, trailers, and/or aerials, is that they are cost intensive. Not many are available in one location. Cost prohibits stockpiling. A second defect is that such trucks, trailers and aerials are limited in their mobility, being typically limited to roads or the like, and further, they require a certain amount of human attendance, raising personnel risk.

Deployment of a more cost effective portable adjustable base, monitor and nozzle system, more cost effective than prior art systems, a system that can be stationed closer to a hazard in times of emergency to minimize fallout, a system that requires less human attendance, a system that is less expensive to stockpile and less expensive if lost, more of which systems, therefore, can be stockpiled for use in case of emergency, and several of which systems can be operated by one remote pump, comprises an improved and advantageous system. Such alternative system (to deploying multiple trucks, aerials or the like) can include the ability to deploy a plurality of systems associated with a plurality of tanks, each attached to one remote pump, to protect a tank farm in case of earthquake or terrorism.

In general, a portable adjustable base/monitor/nozzle system can frequently be staged closer to a hazard, such as a tank surface, possibly on a portion of a target tank wall rim itself or at least on nearby structure such as piping or on a portable frame, thereby eliminating or minimizing loss of foam to “fallout”. The portable adjustable base/monitor/nozzle apparatus system of the instant invention is not only more mobile in the sense that it can be set up closer to a tank, if not on the tank wall rim itself but is also more mobile in the sense than it can be located more precisely vis-à-vis prevailing winds, being less limited as to traversing terrain. As a result of the instant invention, more foam should reach a tank surface, less foam should be carried away by path dispersion and crosswinds, the cost of potential equipment loss can be minimized, the maximum equipment can be stockpiled in anticipation of emergency, and human risk can be minimized.

In regard to maiming loss and maximizing equipment stockpiling, note that the portable adjustable base/monitor/nozzle system of the instant invention is less expensive than a fire truck, trailer, aerial or the like, so that a tank firm or plant could have a plurality on hand in the event of a disaster, for instance, that displaced multiple roofs at the same location and at the same time. The cost is less if the equipment is lost. One remotely staged pump, either as an independent pump or as a pump associated with a fire truck, stationed more remotely than a plurality of portable adjustable base/monitor/nozzle systems, could regulate a plurality of systems, including activating them in series. Personnel associated with the pump could be stationed more remotely also.

Applying foam to a tank surface or other hazard area from a first system, prior to completing the establishing of a second system at a more cost effective location, can lessen the risk of loss of equipment and/or human life while setting up the second system, which second system in turn is located at a more cost effective and optimal location. More optimal locations would typically be as close as possible to hazards or tank surfaces, in order to minimize loss from “fallout”. One optimal location is a rim of a target tank wall. Another optimal location might be the ground proximate a tank or hazard.

In one embodiment, the improved methodology of the instant invention involves using what is referred to as two foam-applying systems, distinct in regard to at least one of location and equipment. For convenience, they are referred to herein as a fist system and a second system. The second system comprises a portable adjustable base/monitor/nozzle apparatus. The portable adjustable apparatus is connected to a source of fire-fighting fluid by an appropriate line and is also connected to a source of foam concentrate, by either a separate line or the same line.

The second system is more cost effective than the first system, at least by location or equipment. Typically, the first system comprises a fire fighting truck, trailer or aerial. However, it should be understood that the first system could comprise a portable adjustable base/monitor/nozzle apparatus in fluid communication with a source of fire fighting fluid and foam concentrate. One key distinction between the first system and the second system is that the second system is more cost effective, by at least either location or equipment. The second system's cost effectiveness may be due primarily to a more advantageous location vis-à-vis the hazard. Preferably it is also due to the lower cost of the equipment, making it cheaper to buy and less to lose if it is sacrificed. In a preferred embodiment, the second system would optimally be attached to a wall rim portion of a tank itself. The usefulness of the less cost effective first system, whatever apparatus it may comprise, is in establishing an initial application of foam. The initial application of foam creates a less risky environment for setting up or completing the set up of the second system. The source of a second system's enhanced cost effectiveness could not only be that it is cheaper equipment and/or that it is located closer to the hazard but also that the second system is located more advantageously with respect to a prevailing wind.

In a typical scenario, comprising one preferred embodiment, a first system would comprise a relatively expensive fire truck or aerial. The truck or aerial would have relatively limited mobility as compared to a portable adjustable base/monitor/nozzle system, the truck or aerial typically being United to roadways or paved ways. The expensive truck or aerial would also have various humans in attendance, creating a double reluctance to place it too close to a tank that is subject to overflow or explosion.

The second system, including a portable adjustable base, monitor and nozzle apparatus, after being set up, would require little to no human attendance and would be less expensive to replace if it were lost. The second system, being relatively inexpensive per se, could be stockpiled by an industrial plant or tank farm or the like, in order to have a plurality of such systems in readiness. It is anticipated that the second systems would be able to be set up and located closer and more strategically than the first system to the hazard. In one embodiment, the first system comprises the same equipment as the second system. The “second system” differs from the “first system” in that, after being initially set up at one location, it is picked up and moved to a more cost effective location.

A further embodiment of the instant invention comprises operating a plurality of portable adjustable base, monitor and nozzle systems, each located proximate to one of a plurality of tanks, from one remote pump. The pump could be a freestanding pump or a pump associated with a fire truck. The pump can be more safely located more remote from the hazard, at least vis-à-vis the location of the portable base/monitor/nozzle system. A remote pump preferably could operate several base/monitor/nozzle systems in sequence in order to establish and/or maintain a foam blanket on a hazard or the surface of a plurality of tanks.

A further improvement in portable adjustable base/monitor/nozzle systems comprises a system that can be mounted on a pipe. A pipe-mounted, portable adjustable base/monitor/nozzle system preferably includes a tie-down strap and a pipe-mounting device. The system may include a support-leg section. The tie-down strap affixes the pipe-mount device to the top of a pipe using a pressure fit. The pressure fit is effective by means of a strap wench attached to the tie-down device. The support-leg section resists torqueing of the pipe-mount device around the pipe during use.

As used herein, the term “portable” contrasts with and distinguishes from a “fixed system” as that phrase is understood in the industry.

“Adjustable” means that the relationship of the monitor/base with its substrate is adjustable, in at least one dimension, and that the relationship with the substrate is adjustable without permanently altering a man-made substrate, such as by boring bolt holes in concrete or steel or by welding (or gluing, conceivably) hooks or eyes to metal in order to receive a monitor/base.

Applying foam to a tank's surface implies applying foam to the surface of the contents of a tank. This surface will usually be liquid, but in the case of a sunken or tilted root a roof might interrupt parts or all of the surface.

Hazardous vapors coming from a tank surface are suppressed when a foam blanket is established and maintained over that surface. Reciting that a second system is more cost effective than a first system in establishing or maintaining such a foam blanket implies that the second system is at least one of less expensive and located more advantageously than the fist system vis-à-vis a tank surface. Both systems could comprise the same equipment, setup in different locations. More typically the first system would comprise a fire truck, aerial, trailer or the like, which is more expensive equipment.

A fire fighting fluid line is usually a hose but could be a pipe or a fixed pipe.

A monitor is a device that permits a nozzle at least one degree of freedom. Preferably, a monitor permits a nozzle two degrees of freedom, typically in azimuth and in inclination.

### SUMMARY OF THE INVENTION

The instant invention includes method and apparatus for protecting a potentially hazardous area from flammable vapors and/or gases and/or fire, and comprises locating or situating a monitor, nozzle and portable adjustable base a suitable distance from a hazard area, the monitor and nozzle being connected to a source of fire fighting fluid. The method can include placing a valve in a line of fluid communication between the nozzle and the source of the fire fighting fluid. The valve is preferably in communication with a flammable vapor and/or gas and/or fire sensor. The sensor and valve can be structured such that upon detection by the sensor of a predetermined hazardous level of vapor, gas or fire, a communication for opening is forwarded to the valve. Opening places the nozzle in communication with fire fighting fluid such that a fire fighting fluid footprint, thrown by the nozzle, fail on at least part of the hazardous area.

In preferred embodiments the nozzle is an automatic (pressure-regulating) nozzle and/or a foam nozzle, possibly self-educting and/or self-metering. Preferably the nozzle is not located above the hazard area but at least 100 feet laterally from the hazard area.

The invention also includes an improved method for hazardous vapor suppression in a tank. The method includes applying foam to the tank surface from a first foam-applying system. Subsequent to initiating the application of foam from the first system, the method includes completing setup of a second portable adjustable foam applying system, the second system differing from the first system by having at least one of a more cost effective location and a lower equipment cost. The method includes establishing or maintaining a foam blanket on the tank surface at least primarily, if not solely, with the second system, and wherein the second system includes portable adjustable base, monitor and nozzle apparatus attached to a fire fighting fluid line. In preferred systems, the first system includes a fire truck, a tailer or an aerial.

The invention also includes a method and apparatus for hazardous vapor and/or fire suppression in a tank comprising setting up or locating a plurality of portable adjustable foam-applying systems, each system including a base, monitor and nozzle, proximate a plurality of tanks. The method includes establishing or maintaining a foam blanket on surfaces of the tanks with the plurality of portable adjustable foam-applying systems and pumping fire fighting fluid to two or more portable adjustable systems using one more remote pump. The more remote pump might be associated with a fire truck. Foam might be thrown from the plurality of nozzles in sequence.

The invention also includes apparatus for hazardous vapor and/or fire suppression wherein a portable adjustable base/monitor/nozzle apparatus includes at least one tie-down strap for encircling at least a six-inch diameter pipe and a pipe-mount device for fixed attachment between the at least one tie-down strap and the monitor. A support leg may be attached between the ground and the pipe-mount device.

### BRIEF DESCRIPTION OF THE DRAWINGS

A better understanding of the present invention can be obtained when the following detailed description of the preferred embodiment is considered in conjunction with the following drawings, in which:

FIG. 1A presents a side illustrative view of a base portion of the apparatus applicable for attachment to a monitor and to hose.

FIG. 1B presents an end view of the apparatus of FIG. 1A having a monitor attached.

FIG. 2A presents a side view of apparatus similar to that in FIG. 1A but of larger size.

FIG. 2B presents an end view of the apparatus of FIG. 2A having monitor attached.

FIG. 3 illustrates a stem attachment providing an auxiliary discharge for the apparatus.

FIG. 4 illustrates a methodology using the present invention.

FIGS. 5A and 5B present side and end views similar to FIGS. 2A and 2B, also illustrating an adjustable lockdown lug.

FIGS. 6A and 6B illustrate a portable frame to provide a suitable wall rim portion to which the monitor apparatus and base structure may be affixed, the frame particularly suitable for bolting to a pickup truck bed.

FIGS. 7A and 7B illustrate an alternate frame for providing a wall rim portion to which the monitor apparatus and base structure may be affixed, the frame of FIGS. 7A and 7B being suitable for locating on the ground.

FIG. 8 illustrates a preferred embodiment of apparatus and method for protecting potentially hazardous areas from flammable vapors and gases, as well as fire extinction.

FIGS. 9-11 illustrate a preferred embodiment of a pipe-mounting system for a portable adjustable base/monitor/nozzle apparatus.

FIG. 12 illustrate methods for deploying a portable base/monitor/nozzle apparatus in addressing hazards.

The drawings are primarily illustrative. It would be understood that structure may have been simplified and details omitted in order to convey certain aspects of the invention. Scale may be sacrificed to clarity.

### DESCRIPTION OF THE PREFERRED EMBODIMENTS

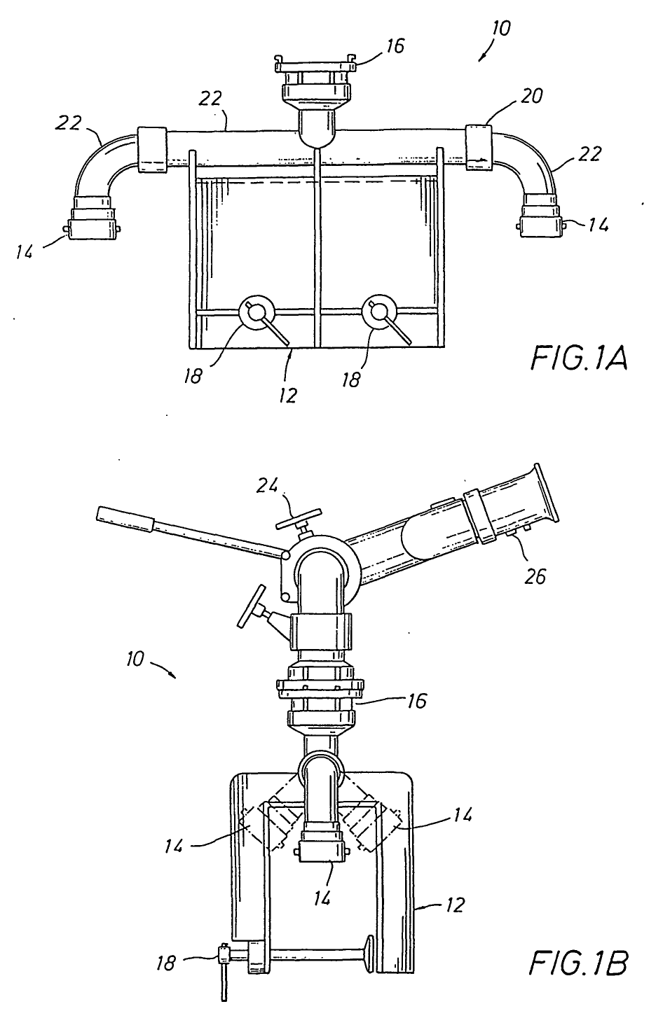

FIG. 1A illustrates portions of a preferred portable adjustable wall-attachable fire fighting apparatus. Apparatus 10 is illustrated in FIG. 1A without monitor 24 attached. FIG. 1B illustrates apparatus 10 with monitor 24 attached. Monitor 24 could be an integral part of the apparatus. Alternately, to enhance versatility, a base could be designed such that the base is attachable, such as by fitting 16, with a variety of monitors.

Referring to FIG. 1A, a base is preferably comprised of a saddle 12 of lightweight construction, such as aluminum. The benefit of lightweight construction is that it may enable a firefighter to carry the apparatus up the ladder of a tank. The saddle shape of base 12 is better illustrated by the end view of FIG. 1B. Base 12 is shown provided with one or more screw clamps 18. A variety of attachment means could be utilized. Screw clamp 18 permits a given base 12 to be attached to a variety of rim walls, from concrete block walls to tank walls to bulldozer blades and pickup truck tailgates.

Base 12 is shown fitted with pipe 22, preferably having swivel connections 20. Pipe 22 preferably ends in one or more hose connections 14. FIG. 1A shows an apparatus designed for a 2½″ hose connection. The apparatus of FIGS. 1A and 1B can likely be made portable by firefighters up a ladder of a tank in an emergency. In FIGS. 1A and 1B a 5″ monitor connection 16 is provided for mating with monitor 24. Again monitor 24 is preferably also constructed of aluminum in order to achieve a lightweight result. Monitor 24 is shown with a 3″ waterway. Nozzle 26 is connected to the outlet end of monitor 24.

Means are provided on a monitor, as is known in the art, to adjust the monitor in azimuth and inclination.

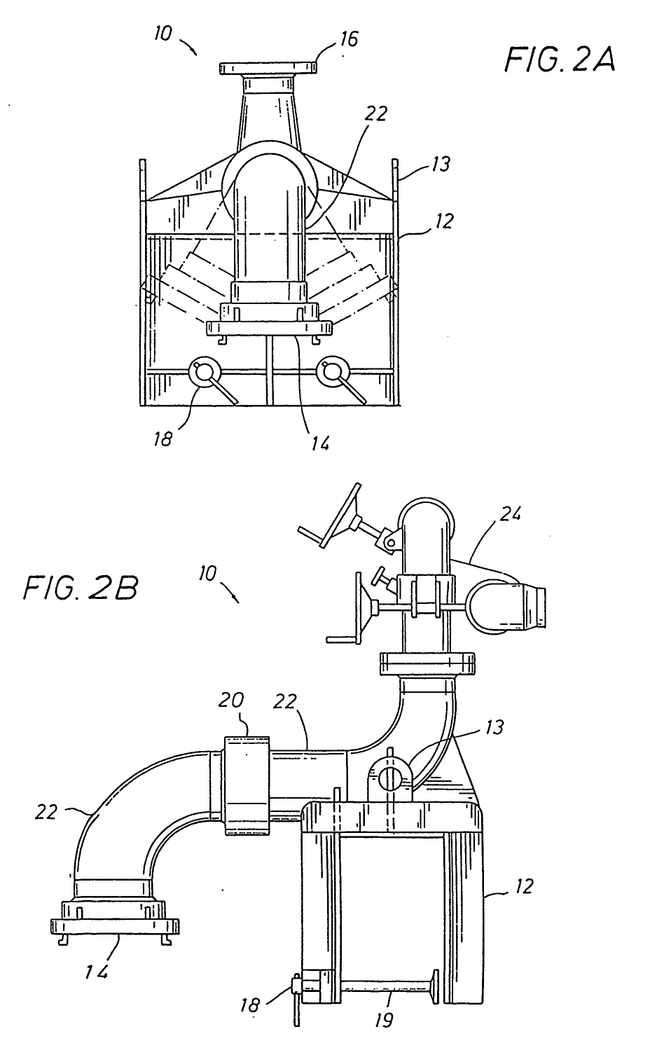

FIGS. 2A and 2B illustrate a larger version of the portable wall attachable fire fighting apparatus. In FIGS. 2A and 2B only one fitting 14 is provided for connection with a hose. FIGS. 2A and 2B illustrate the placement of lifting eye 13 to permit the portable wall-attachable fire fighting apparatus to be lifted into place by a crane. Monitor 24 is shown providing a 4″ waterway with a dual hand-wheel and a 3½″ outlet. The apparatus is shown having a 4″ flanged monitor connection 16. Provision is made for a 5″ hose connection 14.

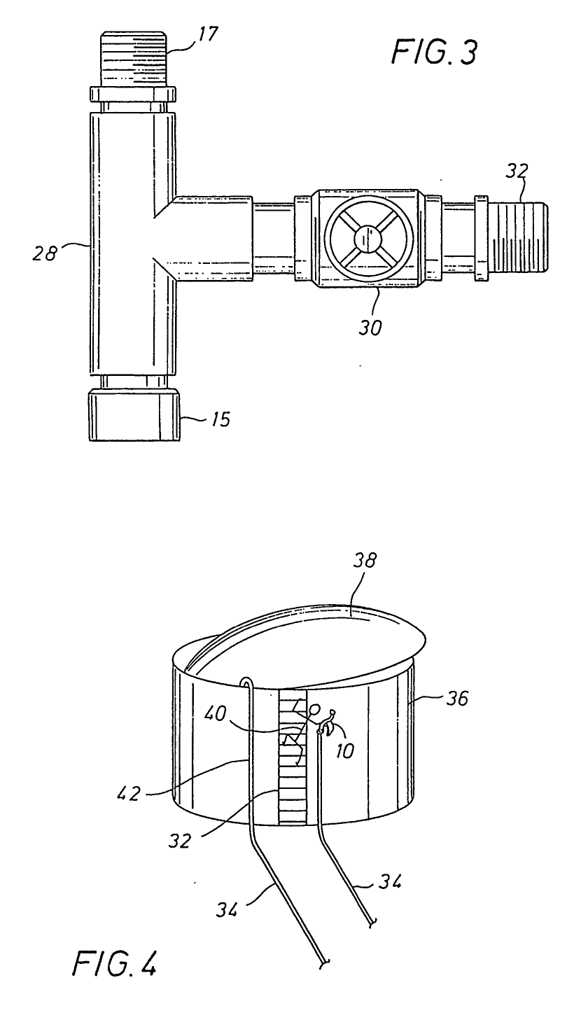

FIG. 3 illustrates a connecting piece 28 that provides an enhancement for the portable wall-attachable fire fighting apparatus. Stem 28 would screw into hose fitting 14 and provide a fitting 15 for connection to a hose. Stem 28 provides valve 30 and auxiliary discharge port 32. The value of stem 28 is to be able to siphon fluid off from the hose prior to delivery to the monitor outlet in order to use the fluid for an auxiliary discharge unit.

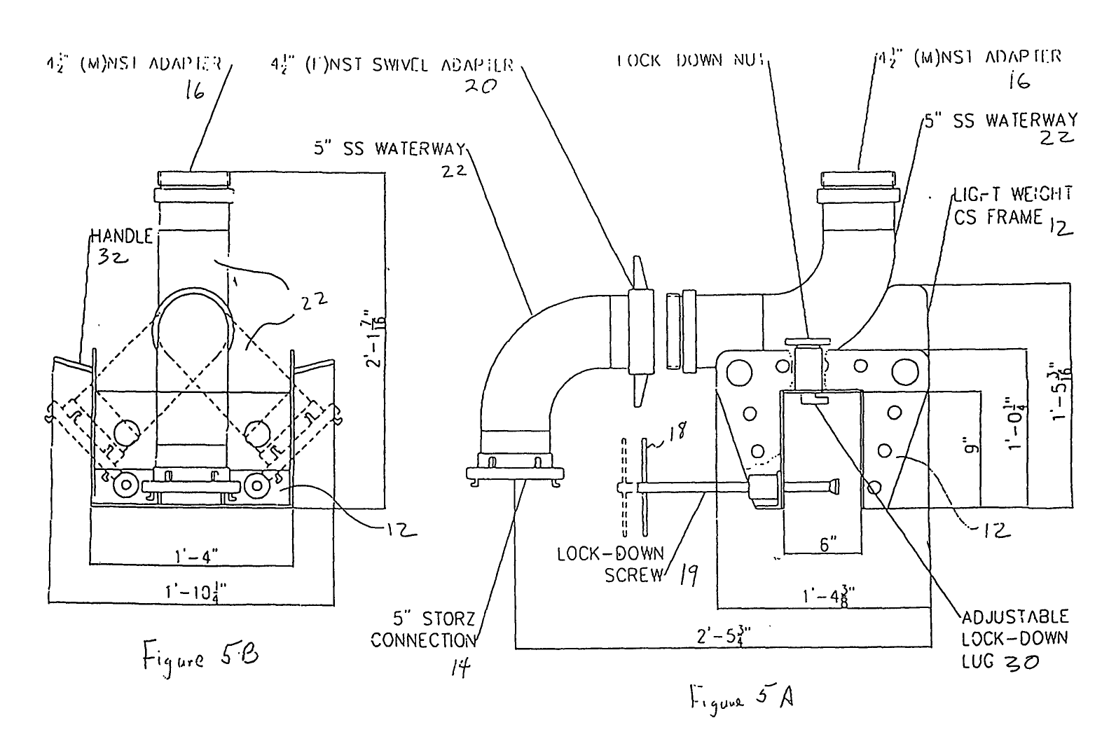

FIG. 4 illustrates portions of the methodology of the present invention. Firefighter 40 is illustrated climbing ladder 32 on the side of tank 36 having a sunken or dislodged roof 38. Firefighter 40 is shown carrying apparatus 10 to the top of the tank wall where it will be set in place. Wand 40 is shown in place connected to hose 34 in order to distribute foam at least over the area immediately below and on both sides of the ladder in the tank for the protection of firefighter 40. Apparatus 10 is connected to hose 34. If apparatus 10 contains an auxiliary discharge port the firefighter may not only adjust the monitor to appropriately target a mainstream of fluid but the firefighter may also attach discharge apparatus to the auxiliary port in order to target secondary areas.

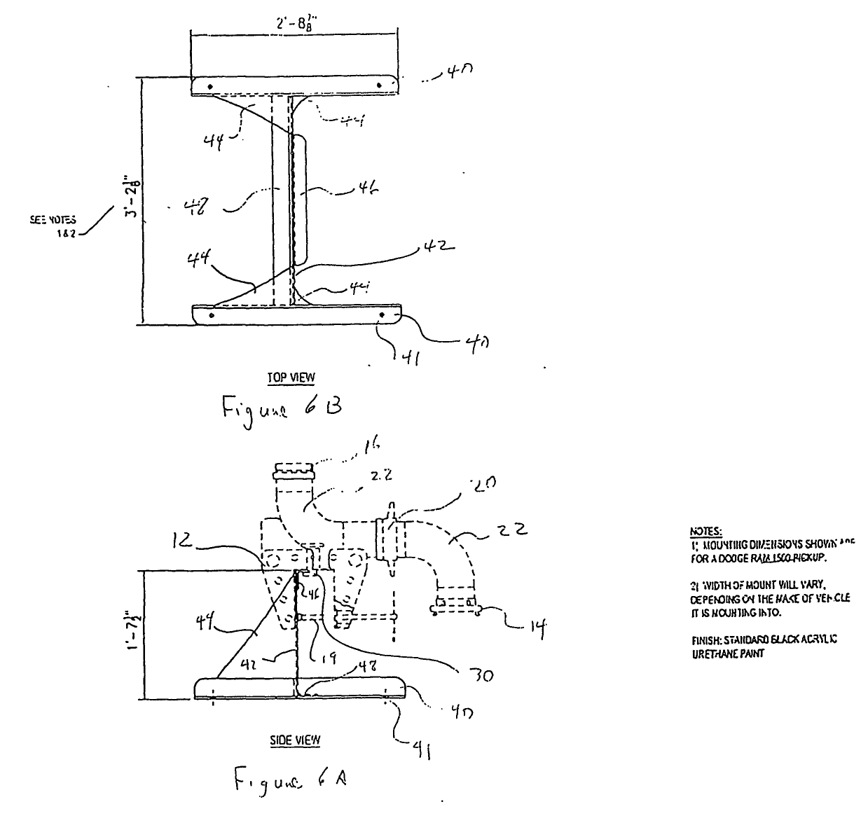

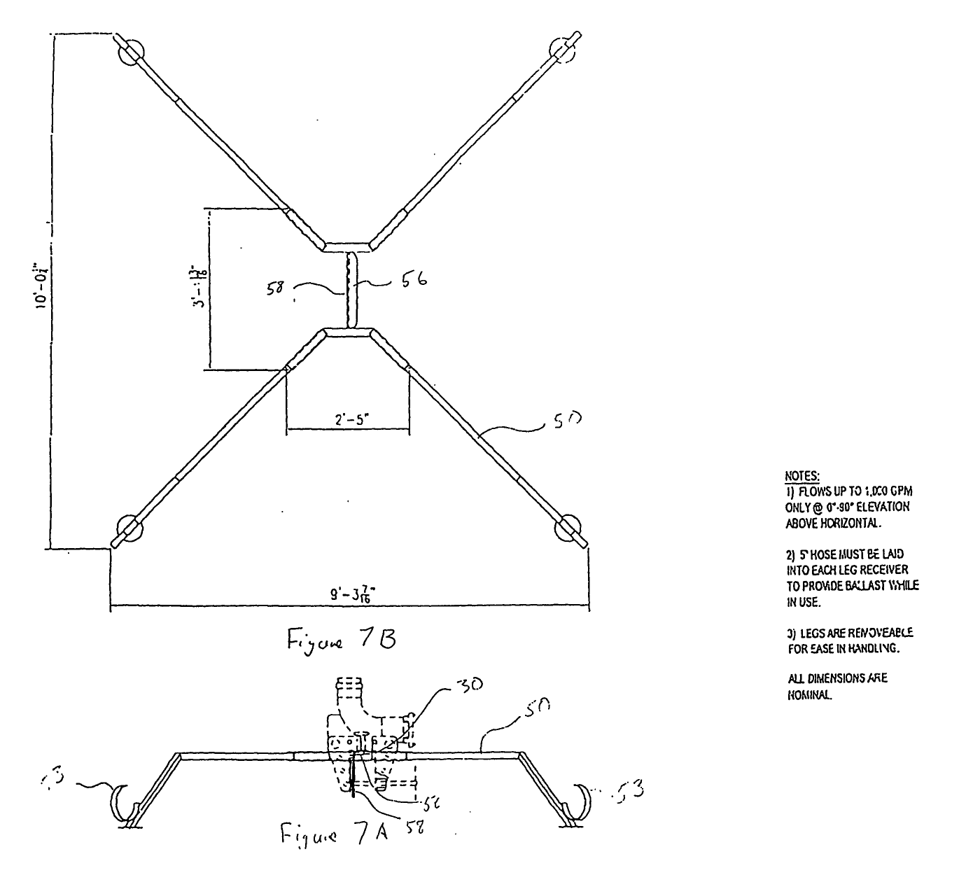

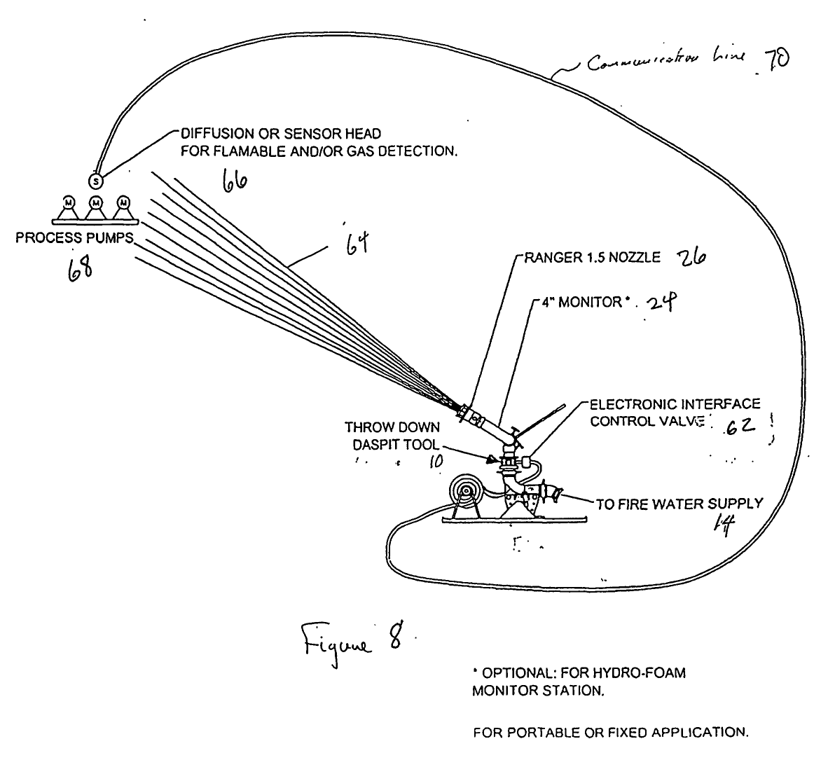

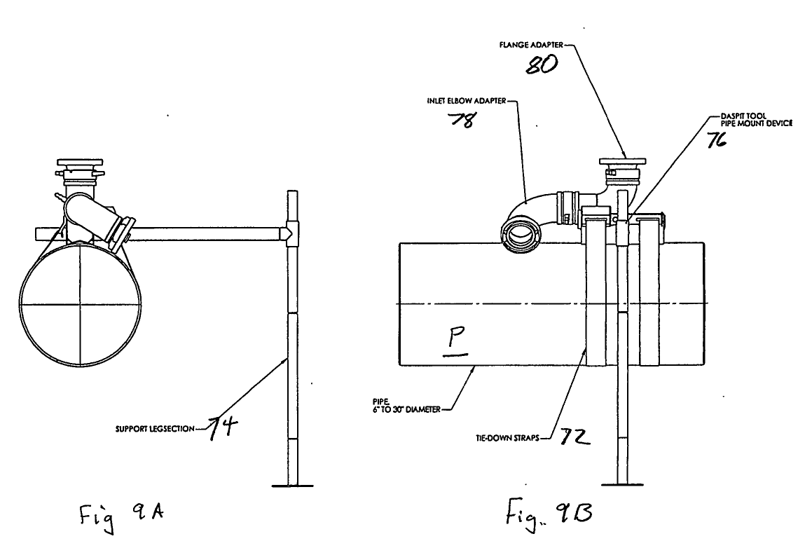

FIGS. 5A and 5B are similar to FIGS. 2A and 2B, discussed above. FIG. 5A, in particular, illustrates an adjustable lockdown lug 30, useful for affixing the portable wall attachable fire fighting apparatus to a wall rim portion provided by a portable frame. As can be seen in FIGS. 6A, 6B, 7A and 7B, lug 30 locks around an angle element 46 or 56, affixed to the wall rim provided by the portable frame.

FIGS. 6A and 6B and 7A and 7B illustrate two embodiments of a portable frame that can be used to provide a wall rim portion to which the portable wall attachable fire fighting apparatus can be attached. The frame of FIGS. 6A and 6B is particularly adapted for being bolted to a pickup truck bed. Frame element 40 comprises pieces of angle iron having bolt holes 41 for becoming affixed to a pickup truck bed. Transverse angle iron element 48 attaches to and between side angle iron elements 40. Vertical plate 42 is affixed between side angle iron frame elements 40. Vertical plate 42 provides the wall rim portion to which the fire fighting apparatus may be attached. Webbing 44 is designed to hold wall element 42 securely in place with respect to frame elements 40 and 48. Preferably, the upper rim of vertical wall portion 42 is firmly secured to an angle rim element 46. Adjustable lockdown lug 30 is designed to lock over a portion of angle iron element 46, helping to further secure the portable fire fighting apparatus to the portable frame. Lockdown screw 19 adjustably attaches the fire fighting apparatus to wall portion 42 provided by the portable frame.

The frame illustrated in FIGS. 7A and 7B is intended to be installed or located upon the ground. Leg strap hose receivers 53 are provided attached to frame legs 50. Leg receivers 53 receive hose to help provide ballast for the frame on the ground. Preferably legs 50 of the frame of FIGS. 7A and 7B would be removable for ease in handling. As in FIGS. 6A and 6B, the frame of FIGS. 7A and 7B provides wall 58 which provides a wall rim portion for attaching the portable fire fighting apparatus. As in FIGS. 6A and 6B, the top of vertical wall 58 is preferably affixed to an angle iron element 56 to help provide a secure attachment for the portable fire fighting apparatus.

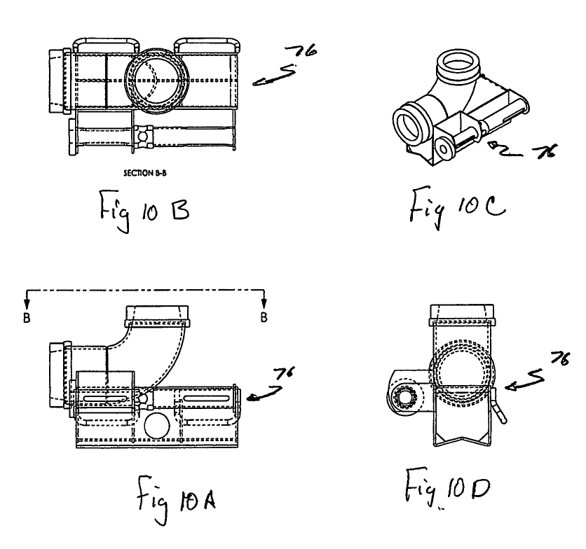

FIG. 8 illustrates an embodiment of apparatus and method of the instant invention, suitable for protecting a potentially hazardous area from flowable vapors and/or gasses and/or fire. The system is characterized by its mobility and flexibility with respect to a hazard area. In this preferred embodiment, a Ranger automatic nozzle 26 is mounted to a monitor 24, based and stabilized on a portable adjustable base/monitor/nozzle apparatus, known as a throw-down Daspit tool 10. An electronic communication line 70 connects the nozzle/monitor/base with a diffusion or sensor head 66 for flammable vapor and/or gas detection. Such sensor head, in the illustration of FIG. 1, is mounted proximate pumps 68 for monitoring the pumps. Communication line 70 connects to an electronic interface control valve 62 associated with the Daspit tool and monitor. The interface control valve 62 could connect between the nozzle and the monitor, between the monitor and the base, between the base and a supply line, or between a supply line and a manifold serving several Daspit tools. Where the valve connects in the fire fighting fluid supply system would likely be dictated by circumstances, possibly on a case-by-case basis.

In operation, when the diffusion or sensor head for flammable vapors and/or gases detects a predetermined level of vapors or gases, a signal is sent through the communication line to the electronic interface control valve. The control valve opens and fire fighting fluid is supplied through interface 14 to monitor 24 and nozzle 26. The Ranger nozzle is an automatic foam nozzle. The nozzle has been structured and located such that its footprint of water/foam covers the hazard while the nozzle itself is stationed a safe distance away.

The fire fighting fluid supply may be water. The water may already contain foam concentrate or foam, or the Ranger nozzle may be connected to a separate supply of foam concentrate or foam, not shown. Foam concentrate may be pumped into and/or may be self-educted into the nozzle. Being an automatic nozzle, the Daspit tool skid has been situated such that the pressure maintained by the automatic nozzle should throw the fire fighting fluid 64 to and over the area of process pumps 68. Even if or when the supply pressure of the fire fighting fluid to the nozzle varies, assuming it does so within an acceptable range, the automatic Ranger nozzle should be able to self-adjust and maintain approximately the range of its throw of fire fighting fluid 64.

The nozzle, monitor and skid are located laterally from any hazard so as to enhance the chance of survival of any explosion or fire at the hazard location, thereby enhancing the survivability of the protection. At least 100 feet is a preferred lateral separation.

Although the throw-down Daspit tool is illustrated as being attached to what could be regarded as a portable skid, the installation, in fact, could utilize many types of bases and even become regarded as almost permanent. Such a temporary or almost permanent installation might provide a more cost effective protective system, with greater survivability for a variety of equipment or pump hazards, than a traditional costly sprinkler system.

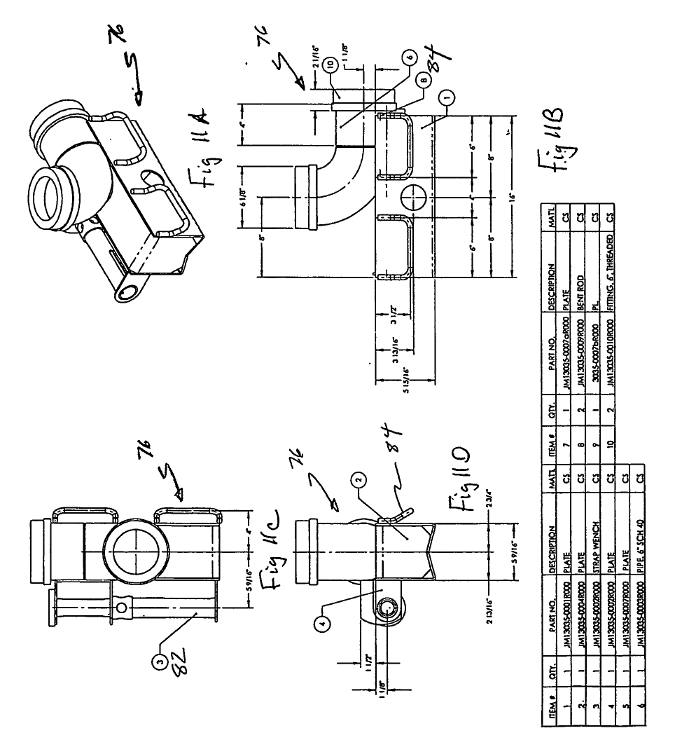

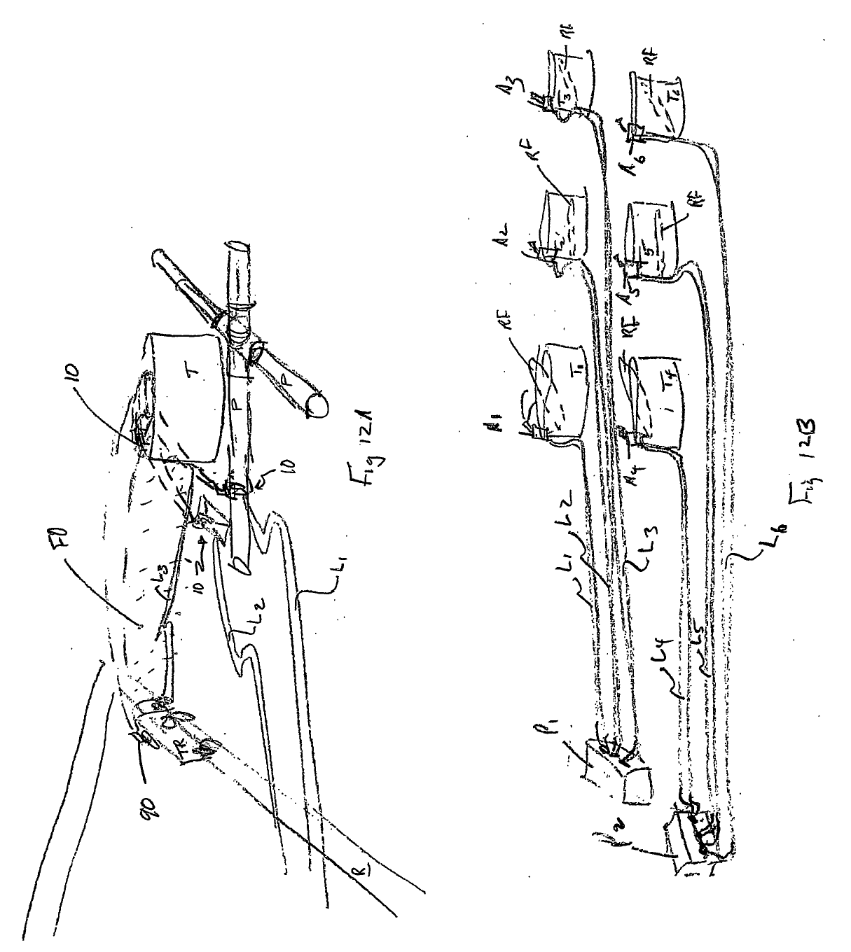

FIGS. 9, 10 and 11 illustrate a portable attachable monitor and base apparatus, designed to adjustably attach to a pipe. Preferably the pipe has a diameter of at least six inches. Further, preferably the pipe diameter is no greater than 30 inches. The base system includes a pipe-mount device illustrated in FIG. 9B as well as in FIGS. 10 and 11. The pie-mount device in the preferred embodiment is secured to the pipe by means of at least one tie-down strap 72. The tie-down strap is secured to the pipe-mount device 76 by means of bent rod handles 84, on the one side, and strap wrench 82 on the other side. The pipe-mount device includes flange adaptor 80 for attachment to a monitor and nozzle. Support leg section 74 helps give lateral support to the pipe-mount device 76. An inlet elbow adaptor 78 is provided for attachment to a hose or line.

FIGS. 12A and 12B illustrate further preferred apparatus and methodology of the instant invention. In FIG. 12A a fast system, comprising nozzle 90 associated with fire truck TR, is shown applying fire fighting fluid, in this instance foam to the interior of tank T. Fallout FO illustrates the foam lost through fallout to the ground, outside the wall of the tank. Truck TR is shown limited in its positioning to roadway R. Subsequent to establishing an initial foam blanket, a second system comprising a portable attachable base/monitor/nozzle device 10 is shown set up in various places around tank T for illustrative purposes. Only one such portable adjustable apparatus system would likely be setup per tank. One portable adjustable apparatus system is shown attached to a top wall rim portion of tank T. A second portable adjustable apparatus system is shown affixed on the ground to a portable frame proximate tank T. A third portable adjustable apparatus system 10 is shown affixed to pipe P proximate to or in the vicinity of tank T. Foam or fire fighting fluid is shown being thrown from the portable attachable apparatus systems on or into the surface of tank T. The portable attachable apparatus systems are shown attached by lines L1, L2 and L3 to sources of fire fighting fluid.

FIG. 12B illustrates a system in which six tanks are shown, T1 through T6, each having a tilted or sunken roof RF. On the wall of each tank a portable adjustable fire fighting apparatus system A1 through A6 is shown attached. Systems A1 through A3 are shown attached by lines L1 through L3 to pump P1. Systems A4 through A6 are shown attached by lines L4 through L6 to pump P2. Pumps P1 and n are remote from the tanks. The attendance of personnel required for the pumps, thus, is not placed in the vicinity of the tanks, were they to explode or overflow. Nozzles associated with the apparatus A1 through A6 could be fired simultaneously and/or sequentially.

In the following claims, when a base and/or a monitor are referred to, it should be understood that one or more bases and one or more monitors could be used. Although the invention can be practiced with one base and one monitor, multiple bases and/or multiple monitors would not change the nature of the invention.

The foregoing disclosure and description of the invention are illustrative and explanatory thereof and various changes in the size, shape, and materials, as well as in the details of the illustrated system may be made without departing from the spirit of the invention. The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof various changes in the size, shape, and materials, as well as in the details of the illustrated device may be made without departing from the spirit of the invention. The invention is claimed using terminology that depends upon a historic presumption that, absent a contrary indication, recitation of a single element covers one or more, and recitation of two elements covers two or more, and the lie. Also, the drawings and illustration herein have not necessarily been produced to scale.

What is claimed is:

1. A method for protecting a potentially hazardous area (hazard area) from flammable vapors and/or gases and/or fire, comprising:
locating a monitor, nozzle and portable adjustable base a suitable distance from the hazard area, the monitor and nozzle connected to a source of fire fighting fluid; and
placing a valve in a line of fluid communication between the nozzle and the source of fire fighting fluid and in communication with a flammable vapor and/or gas and/or fire sensor, the sensor and valve structured such that
upon detection by the sensor of a predetermined hazardous level of vapor, gas, or fire, a communication for opening is forwarded to the valve and wherein opening places the nozzle in communication with fire fighting fluid such that a fire fighting fluid footprint thrown by the nozzle falls on at least part of the hazard area.

2. The method of claim 1 wherein the nozzle is an automatic nozzle.

3. The method of claim 1 wherein the nozzle is a foam nozzle.

4. The method of claim 1 wherein the nozzle is a not located above the hazard area.

5. The method of claim 1 wherein the nozzle is located at least 100 feet laterally from the hazard area.

6. The method of claim 1 that includes adjusting at least two degrees of freedom of the monitor to aim the nozzle toward the hazardous area.

7. The method of claim 1 wherein the nozzle is a self-educting, self-metering automatic foam nozzle.

8. The method of claim 1 wherein the base includes at least one of a saddle and a tie-down strap.

9. The method of claim 1 wherein the sensor is located proximate the hazard area.

10. Apparatus for protecting a potentially hazardous area (hazard area) from flammable vapors and/or gases and/or fire, comprising:
a monitor connecting a nozzle and a portable adjustable base, the monitor in fluid communication with a source of fire fighting fluid;
a valve placed in a line of fluid communication between the nozzle and the source of fire fighting fluid; and
a flammable vapor and/or gas and/or fire sensor in communication with the valve.

11. The apparatus of claim 10 wherein the nozzle is an automatic nozzle.

12. The apparatus of claim 10 wherein the nozzle is a foam nozzle.

13. The apparatus of claim 10 wherein the nozzle is a self-educting, automatic nozzle.

14. The apparatus of claim 10 wherein the monitor adjusts for two degrees of freedom for the nozzle.

15. The apparatus of claim 10 wherein the sensor is located proximate the hazard area.

16. An improved method for hazardous vapor suppression in a tank, comprising:
applying foam to the tank surface from a first foam applying system;
subsequent to initiating the applying, completing setup of a second portable adjustable foam applying system, the second system differing from the first system by having at least one of (1) a more cost effective location and (2) a lower equipment cost;
establishing or maintaining a foam blanket on the tank surface at least primarily, if not solely, with the second system; and
wherein the second system includes portable adjustable base, monitor and nozzle apparatus attached to a fire fighting fluid line.

17. The method of claim 16 that includes ceasing to apply foam to the tank using the first system after the second system is set up.

18. The method of claim 16 wherein the first system includes a fire truck, a trailer or an aerial.

19. The method of claim 16 wherein the second system has both a more cost effective location and a lower equipment cost than the first system.

20. The method of claim 16 wherein the equipment of the first system is less mobile than that of the second system in regard to locating vis-à-vis a tank.

21. The method of claim 16 wherein the second system is attached to a source of foam concentrate.

22. The method of claim 16 wherein the portable adjustable base, monitor and nozzle apparatus of the second system is adapted to attach over a wall rim portion.

23. The method of claim 16 wherein the portable adjustable base, monitor and nozzle apparatus of the second system is attached to a portable frame.

24. The method of claim 16 that includes setting up a plurality of second systems to blanket a plurality of tank surfaces with foam, the plurality of second systems in fluid communication with one more remote pump.

25. An improved method for hazardous vapor and/or fire suppression in a tank, comprising:
setting up a plurality of portable adjustable foam applying systems, each system including a base, monitor and nozzle, proximate a plurality of tanks;
establishing or maintaining a foam blanket on surfaces of the tanks with the plurality of portable adjustable foam applying systems; and
pumping fire fighting fluid to two or more portable adjustable systems with one more remote pump.

26. The method of claim 25 wherein the pump is associated with a fire truck.

27. The method of claim 25 that includes throwing foam from the plurality of nozzles in sequence.

28. Apparatus for improved hazardous vapor and/or fire suppression, comprising:
a plurality of systems, each system including a portable adjustable base, monitor and nozzle apparatus;
each system stationed on or proximate to a separate hazardous vapor tank; and
wherein the plurality of systems are in fluid communication with one more remote pump.

29. Apparatus for improved hazardous vapor and/or fire suppression, comprising:
portable adjustable base/monitor/nozzle apparatus including at least one tie-down strap for encircling at least a six-inch diameter pipe and a pipe-mount device for fixed attachment between the at least one tie-down strap and the monitor.

30. The apparatus of claim 29 including at least one support leg for attachment between a ground and the pipe-mount device.
